(19) United States
(12) Patent Application Publication
(10) Pub. No.: US 2016/0037718 A1
(43) Pub. Date: Feb. 11, 2016

(54) Debris Deflector And Method For Zero Turn Riding Mower

(71) Applicant: Dennis Reid, SR., Stanley, NC (US)

(72) Inventor: Dennis Reid, SR., Stanley, NC (US)

(21) Appl. No.: 14/819,666

(22) Filed: Aug. 6, 2015

Related U.S. Application Data
(60) Provisional application No. 62/034,506, filed on Aug. 7, 2014.

(51) Int. Cl. A01D 34/81; A01D 34/76; A01D 34/64

(52) U.S. Cl. CPC A01D 34/81; A01D 34/64; A01D 34/76; A01D 2101/00

(57) ABSTRACT

A debris deflector and an associated method are provided for preventing debris from entering the drive belt and pulley compartment of a riding mower. The debris deflector includes a generally planar top portion, a front portion that depends downwardly from the front portion, and a rear portion that extends upwardly from the top portion. The front portion has a plurality of through holes and a vertical flange on the riding mower has a plurality of tapped holes configured for receiving a corresponding plurality of fasteners to secure the front portion of the deflector to the vertical flange. The method includes providing the deflector, forming the plurality of holes through the front portion of the deflector, tapping the plurality of holes in the vertical flange, and securing the deflector to the vertical flange using the plurality of fasteners such that the top portion of the deflector prevents debris from entering at least a center section of the drive belt and pulley compartment.

### CROSS REFERENCE To RELATED APPLICATIONS

This application claims priority to U.S. Provisional Application No. 62/034,506 filed on Aug. 7, 2014, the disclosure of which is incorporated herein by reference in its entirety.

### FIELD OF THE INVENTION

The present invention relates generally to accessories for lawn mowing equipment, and more particularly, to a device and method for preventing debris from entering the drive belt and pulley compartment of a riding mower. In an exemplary embodiment, the invention is a debris deflector and an associated method for preventing debris from potentially damaging a drive belt of a zero turn riding mower.

### BACKGROUND OF THE INVENTION AND RELATED ART

Riding mowers are utilized for commercial vegetation maintenance, and in particular, for cutting grass and weeds. The most widely used type of riding mower is commonly referred to as a “zero turn” mower because of its capability to perform sharp turns in a small radius, for example around trees, bushes, shrubbery and other obstacles. Zero turn mowers are manufactured by The Toro® Company and by Deere® and Company. Zero turn mowers typically include a mower deck having an operator's seat mounted thereon, a combustion engine mounted on the rear of the mower deck, and a plurality of cutting blades mounted below the mower deck on rotating drive spindles. A drive belt couples the power take-off (PTO) of the engine to the drive spindles via a series of pulleys to turn the cutting blades. Zero turn riding mowers also include a transmission, drivetrain and steering system for maneuvering the mower across the ground.

For the most part, zero turn riding mowers function efficiently and operate reliably. The most common mechanical failure of a zero turn riding mower is a drive belt failure. The drive belt may begin to sip due to excessive wear. A drive belt failure also occurs when the drive belt disengages from a pulley, splits or breaks. Drive belt wear cannot be avoided. The likelihood of occurrence of other drive belt failures, however, can be significantly reduced. Most often, the drive belt disengages from a pulley, splits or breaks as a result of debris entering the drive belt and pulley compartment. The drive belt and pulley compartment is located on the top of the mower deck, and thus, is substantially protected from debris below the mower deck in the area of the rotating cutting blades. However, debris is oftentimes thrown up in front of the riding mower. Unfortunately, nothing is provided on a zero turn mower to prevent debris from entering the drive belt and pulley compartment from the front of the mower.

Debris entering the drive belt and pulley compartment from the front of the mower may consist of grass clippings, trash, sticks, and small stones, such as gravel. Grass clippings can accumulate in the drive belt and pulley compartment. If not removed periodically, the moist grass clippings can cause the metal structure to rust and/or corrode. If allowed to accumulate, the grass clippings can clog the drive belt and pulley compartment sufficiently to interfere with rotation of the cutting blades. Trash, sticks and small stones can become lodged between the drive belt and a pulley, thereby causing the drive belt to disengage from the pulley, split, crack or break. Each of these situations requires periodic maintenance and/or repair of the riding mower. The maintenance and repair is time consuming and may be costly in terms of a replacement drive belt, and furthermore, in the downtime associated with the maintenance and/or repair.

At the very least, debris entering the drive belt and pulley compartment can cause the expenditure of time, effort and money that is not being utilized to operate the riding mower. In the case of a commercial operator, the time, effort and money required to maintain the drive belt and pulley compartment, and further to replace or repair the drive belt when necessary, reduces the profit of the business enterprise. Accordingly, there exists a need for a device and method for preventing debris from entering the drive belt and pulley compartment from the front of a riding mower. More specifically, there exists a need for a debris deflector and an associated method for preventing debris from entering the drive belt and pulley compartment of a zero turn riding mower and potentially damaging a drive belt of the zero turn mower. There exists a particular need for a deflector that is configured to be readily mounted to the mower deck of a riding mower to shield the drive belt and pulley compartment from debris.

### SUMMARY OF THE INVENTION

In one aspect, the present invention is embodied by a debris deflector for preventing debris from entering a drive belt and pulley compartment on a riding mower. The debris deflector includes a generally planar top portion and a front portion depending downwardly from the top portion. The front portion includes two half portions separated by a relief cut and formed at an acute angle relative to one another. The front potion further has a plurality of through holes configured for receiving a corresponding plurality of fasteners to secure the deflector to the riding mower such that at least the top portion prevents debris from entering the drive belt and pulley compartment of the riding mower.

In one embodiment, the plurality of fasteners secures the front portion to a vertical flange that depends upwardly from a mower deck of the riding mower. The geometry of the two half portions of the front portion corresponds to the geometry of the vertical flange that extends upwardly from the mower deck of the riding mower. Preferably, the geometry of the two half portions corresponds to the geometry of the vertical flange adjacent a center section of the drive belt and pulley compartment. Preferably, the top portion is configured to cover at least the center section of the drive belt and pulley compartment on the mower deck of the riding mower.

In another embodiment, the debris deflector further includes a rear portion opposite the front portion and extending upwardly from the top portion. The rear portion extends upwardly from the top portion at an obtuse angle.

In another embodiment, the top portion of the debris deflector has a grease filling hole for providing access to lubricate a center spindle disposed within a center section of the drive belt and pulley compartment. In another embodiment, the top portion includes at least one relief for providing access to an outboard spindle disposed within an outboard side section of the drive belt and pulley compartment. In yet another embodiment, the top portion includes a pair of reliefs for providing access to lubricate a pair of corresponding outboard spindles disposed within opposite outboard side sections of the drive belt and pulley compartment.

In another aspect, the present invention is embodied by a method of preventing debris from entering a drive belt and pulley compartment disposed on a riding mower. The method includes providing a debris deflector configured for attachment to the riding mower, wherein deflector includes a top portion, a front portion depending downwardly from the top portion, and a rear portion opposite the forward portion that extends upwardly from the top portion. The method further includes forming a plurality of holes through the front portion of the deflector. The method further includes forming a plurality of tapped holes in the riding mower that correspond to the plurality of through holes formed in the front portion of the deflector. The method further includes providing a plurality of fasteners and securing the deflector to the riding mower with the fasteners disposed in the holes formed in the front portion and the tapped holes formed in the riding mower such that at least the top portion prevents debris from entering the drive belt and pulley compartment.

In one embodiment, the riding mower includes a mower deck on which the drive belt and pulley compartment is disposed and a vertical flange that extends upwardly from the mower deck. The method further includes forming the geometry of the front portion to correspond to the geometry of the vertical flange. The method further includes forming the front portion of the deflector into two half portions separated by a relief cut and formed at an acute angle relative to one another. The method further includes securing the two half portions of the front portion of the deflector to the vertical flange on the mower deck of the riding mower such that the top portion covers at least a center section of the drive belt and pulley compartment.

In yet another aspect, the present invention is embodied by a debris deflector for preventing debris from entering a drive belt and pulley compartment disposed on a mower deck of a riding mower. The debris deflector includes a deflector made of a lightweight, formable material. The deflector includes a generally planar top portion, a front portion that depends downwardly from the top portion, and an opposite rear portion that extends upwardly from the top portion. The front portion includes two half portions that are separated by a relief cut and formed at an acute angle relative to one another. The geometry of the two half portions of the front portion corresponds to the angled geometry of a vertical flange that extends upwardly from the mower deck of the riding mower adjacent at least a center section of the drive belt and pulley compartment. The front portion has a plurality of through holes configured to receive a corresponding plurality of fasteners to secure the front portion of the deflector to the vertical flange such that the top portion prevents debris from entering at least the center section of the drive belt and pulley compartment.

### BRIEF DESCRIPTION OF THE DRAWINGS

The aforementioned objects, features and advantages of the present invention will be more fully understood and appreciated when considered in conjunction with the accompanying drawings, in which like reference characters designate the same or similar parts throughout the several views.

FIG. 1 is a perspective view showing a conventional zero turn riding mower of the type utilizing a device and method according to an exemplary embodiment of the present invention.

FIG. 2 is a top view showing the drive belt and pulley compartment of the riding mower of FIG. 1.

FIG. 3 is a top perspective view of a debris deflector according to an exemplary embodiment of the present invention.

### DETAILED DESCRIPTION OF EXEMPLARY EMBODIMENTS

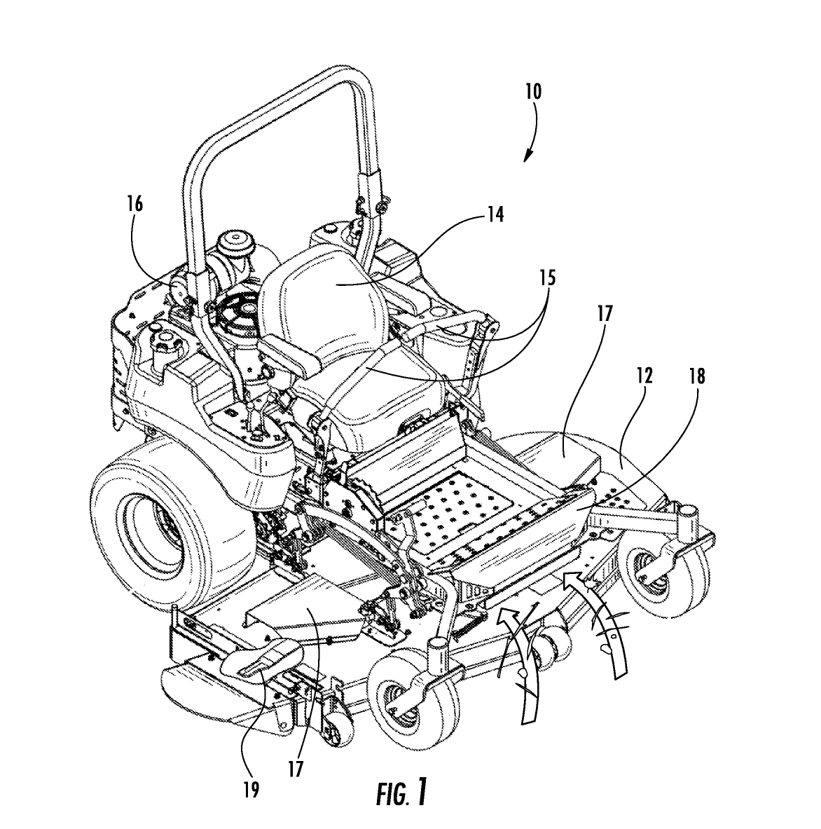

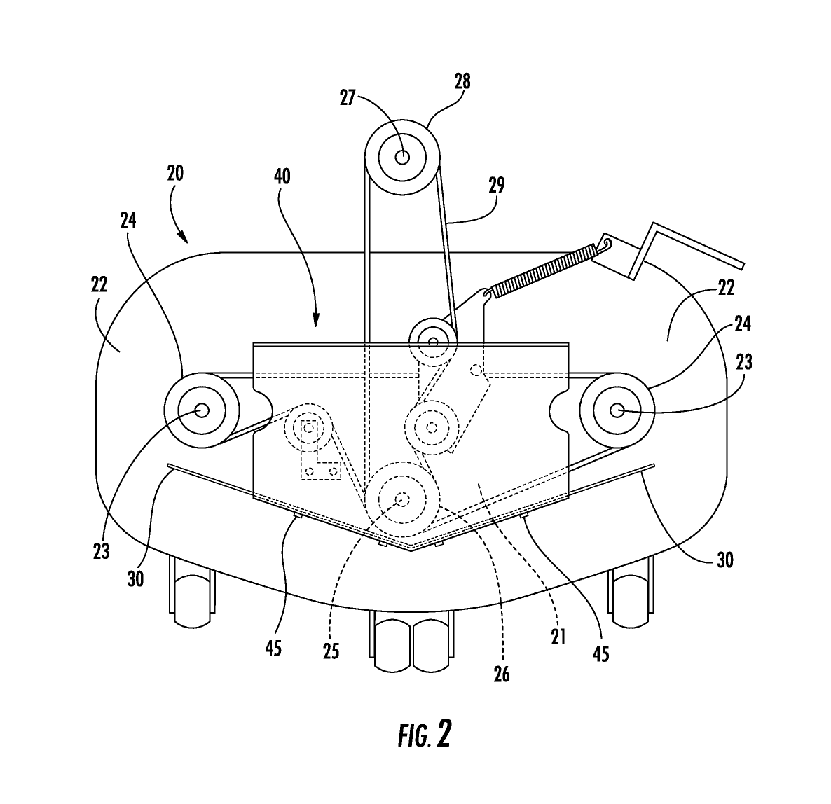

FIG. 1 shows a conventional riding mower commonly known as a zero turn riding mower. The riding mower is referred to as “zero turn” because of its ability to turn about in an extremely small radius for the purpose of maneuvering around obstacles, such as trees, shrubs, planters, gardens and the like. The zero turn riding mower is indicated herein generally by the reference character 10 and is also referred to as the “riding mower” or merely the “mower.” The riding mower 10 comprises a mower deck 12, an operator's seat 14 mounted on the mower deck 12, and a combustion engine 16 mounted on top of the mower deck 12 and behind the operator's seat 14. Control handles 15 disposed adjacent the operator's seat 14 are used to maneuver the riding mower 10. A guard 17 on either side of the operator's seat covers and protects the outboard spindles 23 and pulleys 24 (FIG. 2), as will be described further. A footrest 18 is pivotally mounted to the mower deck 12 to provide access to a drive belt and pulley compartment 20 (FIG. 2) disposed on a forward portion of the mower desk. One or more outboard cutting blades 19 are disposed beneath the mower deck 12 and rotatably mounted on the outboard spindles 23 operably coupled to the corresponding pulleys 24. Similarly, a third cutting blade (not shown) is rotatably mounted on a center spindle 25 operably coupled to a corresponding pulley 26 (FIG. 2).

FIG. 2 shows the drive belt and pulley compartment 20 disposed on the top side of the mower deck 12. As previously mentioned, the footrest 18 can be pivoted upwards relative to the mower deck 12 to provide access to the center section 21 of the drive belt and pulley compartment 20. Similarly, guards 17 can be pivoted upwardly and outwardly, or removed, to provide access to the outboard side sections 22 of the drive belt and pulley compartment 20. As previously mentioned, the guards 17 cover and protect outboard spindles 23 and pulleys 24 that are operably coupled to corresponding outboard cutting blades 19 (FIG. 1) mounted beneath the mower deck 12 for rotation with the outboard spindles. A center spindle 25 and pulley 26 are disposed within the center section 21 and operably coupled to a corresponding center cutting blade (not shown) mounted beneath the mower deck 12 for rotation with the center spindle. An engine spindle 27 and pulley 28 mounted on a rearward portion of the mower deck 12 are operably coupled to the combustion engine 16. A drive belt 29 is routed around the engine pulley 28, the outboard pulleys 24, the center pulley 26 and various tension and idler pulleys. Accordingly, the combustion engine 16 drives the engine spindle 27 to rotate pulley 28. Rotation of pulley 28 in turn drives pulleys 24 and outboard spindles 23 to thereby rotate the outboard cutting blades 19, as well as pulley 26 and center spindle 25 to thereby rotate the center cutting blade.

A relatively thin, vertical flange 30 is also disposed on the forward portion of the mower deck 12. Flange 30 extends upwardly from the mower deck 12 to an elevation slightly above spindles 23, 25 and corresponding pulleys 24, 26. The flange 30 adds structural rigidity to the mower deck 12 and, in some instances, may provide support for the guards 17 and/or the footrest 18 in their downwardly pivoted positions. However, the vertical flange 30 leaves a significant opening between the top surface of the mower deck 12 and the underside of the footrest 18 that allows debris to enter the drive belt and pulley compartment 20 from the front of the riding mower 10. The manner in which debris may be allowed to enter the drive belt and pulley compartment 20 from the front of a conventional zero turn riding mower is depicted by the curved arrows in FIG. 1. The debris may be in the form of grass clippings, trash, sticks and small stones, such as gravel. An accumulation of moist grass clippings can cause the drive belt and pulley compartment 20 and its metal components, such as spindles 23, 25 and pulleys 24, 26, to rust and deteriorate over time. Consequently, time consuming periodic maintenance must be performed to prevent rust and deterioration of the drive belt and pulley compartment 20. Trash, sticks and stones entering the drive belt and pulley compartment 20 can become lodged between the drive belt 29 and an outboard pulley 23 or the center pulley 25. In either instance, the drive belt 29 can split, break or become disengaged (i.e., dislodged) from the pulley. Significant effort, expense and downtime of the mower 12 is required install a replacement drive belt 29, which results in a loss of revenue for a commercial operator.

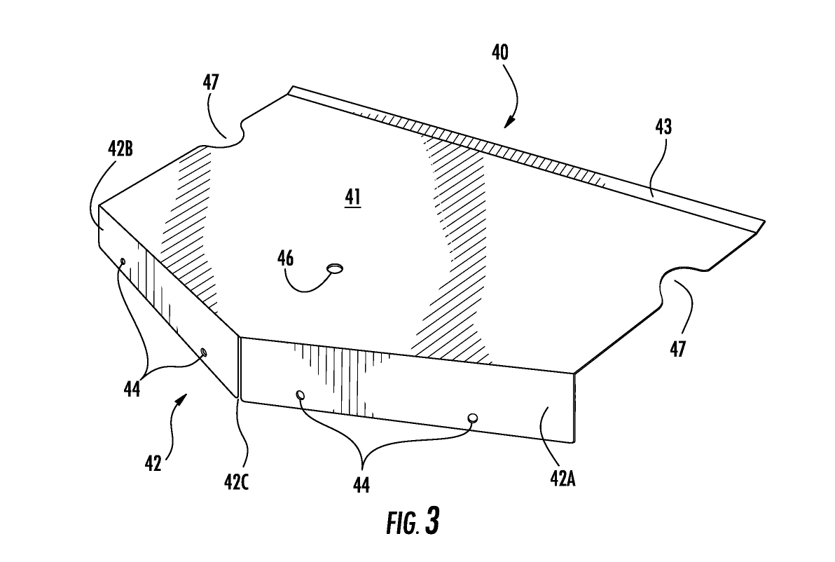

FIG. 3 shows an exemplary embodiment of a debris deflector 40 for use with a zero turn riding mower 10. The deflector 40 is configured to cover the center section 21 of the drive belt and pulley compartment 20, and thereby prevent debris from entering the drive belt and pulley compartment from the front of the riding mower 10. The deflector 40 comprises a generally planar top portion 41, a forward portion 42 depending downwardly from the top portion, and a rear portion 43 opposite the front portion that depends upwardly from the top portion. The front portion 42 may comprise two half portions 42A, 42B separated by a thin relief cut 42C and formed at an acute interior angle relative to one another that corresponds to the angled geometry of the vertical flange 30 adjacent the center section 21 of the drive belt and pulley compartment 20. The rear portion 43 may be formed at an obtuse angle relative to the top portion 41, as shown herein. A plurality of holes 44 are formed through the front portions 42A, 42B to receive fasteners 45 (FIG. 2) that secure the deflector 40 onto the vertical flange 30 of the mower deck 12. In one embodiment, the deflector 40 is made of a lightweight, formable material, such as metal. In yet another embodiment, the deflector 40 is made of relatively thin aluminum sheet metal material.

In an advantageous embodiment, two holes 44 are formed through front portion 42A and two holes 44 are formed through front portion 42B. The four holes 44 are then used to mark locations on vertical flange 30 for receiving the fasteners 45. A 9/32 drill bit may be used at each location to create a starter hole for a 5/16 tap. The front portions 42A and 42B of deflector 40 are then positioned over the tapped holes on the vertical flange 30 and the fasteners 45 are engaged with the tapped holes to secure the deflector 40 on the flange 30. Fasteners 45 may be threaded wing nuts, threaded wheel nuts, threaded hex head bolts, or the like. Once secured on the vertical flange 30, top portion 41 covers the center section 21 of the drive belt and pulley compartment 20 to thereby prevent grass clippings, trash, sticks and stones (e.g., gravel) from entering the compartment from the front of the riding mower 10.

In another embodiment, the deflector 40 shown in FIG. 3 further comprises a grease filling hole 46 that is disposed over the spindle 25 of the pulley 26 mounted within the center section 21 of the drive belt and pulley compartment 20. As a result, the deflector 40 need not be removed to access and lubricate the spindle 25 with the deflector positioned on and securely attached to the vertical flange 30. Deflector 40 may further comprise a semi-circular relief 47 adjacent each of the guards 17 that cover the outboard side sections 22 of the drive belt and pulley compartment 20. In some embodiments, the reliefs 47 may provide access to the spindles 23 for purposes of lubrication. Together, the deflector 40 and the guards 17 sufficiently cover the center section 21 and the outboard side sections 22 of the drive belt and pulley compartment 20 from grass clippings, trash, sticks and stones that may enter the compartment from the front of the riding mower 10.

A method of preventing debris from entering the drive belt and pulley compartment 20 of a riding mower 10 from the front of the mower comprises providing the riding mower 10 with a debris deflector 40 configured to cover and protect the center section 21 of the compartment. The method further comprises forming a downwardly extending front portion 42 of the deflector to correspond to the geometry of a vertical flange 30 that extends upwardly from the mower deck 12 of the riding mower 10. Typically, the flange 30 is angled in a rearward direction from the center of the mower deck 12 and is symmetric about a longitudinal centerline of the riding mower 10. The method further comprises forming a plurality of holes 44 in the forward portion(s) 42A, 42B of the deflector 40 that are configured to receive fasteners 45 to thereby secure the deflector to the vertical flange 30 provided on the mower deck 12 of the riding mower 10. The method further comprises securing the deflector 40 to the vertical flange 30 using the fasteners 45 such that the deflector covers the center section 21 of the drive belt and pulley compartment 20 sufficiently to prevent debris from entering the drive belt and pulley compartment from the front of the riding mower 10.

Regardless of the foregoing detailed description of exemplary embodiments of the invention, the optimum dimensional relationships for the individual components of the invention, including variations in size, shape, thickness, form, materials, function and manner of operation, assembly and use, as well as equivalents thereof, are deemed to be readily apparent and understood by those skilled in the art. Accordingly, equivalent relationships to those illustrated in the drawing figures and described in the written description are intended to be encompassed by the present invention, the foregoing being considered as illustrative only of the principles of the invention. Furthermore, since numerous modifications and changes will readily occur to those skilled in the art, the exemplary embodiments disclosed herein are not intended to limit the invention to the specific configuration, construction, materials and operation shown and described. Instead, all reasonably predictable and suitable equivalents and obvious modifications to the invention should be construed as falling within the scope of the invention as defined by the appended claims given their broadest reasonable interpretation in view of the foregoing written description and accompanying drawings. In particular, the scope of the claims should not be limited by the exemplary embodiments provided herein, but instead should be given the broadest possible interpretation consistent with the description as a whole.

That which is claimed is:

1. A debris deflector for a riding mower, comprising:
a generally planar top portion; and
a front portion depending downwardly from the top portion, the front portion comprising two half portions separated by a relief cut and formed at an acute angle relative to one another, the front potion further having a plurality of through holes configured for receiving a corresponding plurality of fasteners to secure the deflector to the riding mower;
wherein the debris deflector prevents debris from entering a drive belt and pulley compartment on the riding mower.

2. The debris deflector according to claim 1, wherein the plurality of fasteners secure the front portion to a vertical flange that depends upwardly from a mower deck of the riding mower.

3. The debris deflector according to claim 2, wherein the geometry of the two half portions of the front portion corresponds to the geometry of the vertical flange that extends upwardly from the mower deck of the riding mower.

4. The debris deflector according to claim 1, further comprising a rear portion opposite the front portion and extending upwardly from the top portion.

5. The debris deflector according to claim 4, wherein the rear portion extends upwardly from the top portion at an obtuse angle.

6. The debris deflector according to claim 1, wherein the top portion has a grease filling hole for providing access to lubricate a center spindle disposed within a center section of the drive belt and pulley compartment.

7. The debris deflector according to claim 1, wherein the top portion comprises at least one relief for providing access to an outboard spindle disposed within an outboard side section of the drive belt and pulley compartment.

8. The debris deflector according to claim 7, wherein the top portion comprises a pair of reliefs for providing access to lubricate a pair of corresponding outboard spindles disposed within opposite outboard side sections of the drive belt and pulley compartment.

9. The debris deflector according to claim 2, wherein the geometry of the two half portions corresponds to the geometry of the vertical flange adjacent a center section of the drive belt and pulley compartment.

10. The debris deflector according to claim 9, wherein the top portion is configured to cover at least the center section of the drive belt and pulley compartment on the mower deck of the riding mower.

11. The debris deflector according to claim 1, wherein the riding mower comprises a mower deck and a drive belt and pulley compartment disposed on the mower deck, and wherein the drive belt and pulley compartment comprises a center section and a pair of opposite outboard side sections with the center section disposed medially between the outboard side sections.

12. The debris deflector according to claim 11, wherein a pair of opposite guards are disposed on the mower deck, and wherein the top portion of the debris deflector is configured to cover the center section of the drive belt and pulley compartment and the guards are configured to cover the outboard side sections.

13. The debris deflector according to claim 11, wherein a movable footrest is disposed on the mower deck for accessing the drive belt and pulley compartment.

14. The debris deflector according to claim 13, wherein the footrest is pivotally mounted on the mower deck and movable to access at least the center section of the drive belt and pulley compartment.

15. A method of preventing debris from entering a drive belt and pulley compartment disposed on a riding mower, the method comprising:
providing a debris deflector configured for attachment to the riding mower, the debris deflector comprising a top portion, a front portion depending downwardly from the top portion, and a rear portion opposite the forward portion that extends upwardly from the top portion;
forming a plurality of holes through the front portion;
forming a plurality of tapped holes in the riding mower that correspond to the plurality of through holes formed in the front portion; and
providing a plurality of fasteners and securing the front portion to the riding mower with the fasteners disposed in the holes formed in the front portion and the tapped holes formed in the riding mower such that at least the top portion prevents debris from entering the drive belt and pulley compartment.

16. The method according to claim 15, wherein the riding mower comprises a mower deck on which the drive belt and pulley compartment is disposed and a vertical flange that extends upwardly from the mower deck.

17. The method according to claim 16, further comprising forming the geometry of the front portion to correspond to the geometry of the vertical flange.

18. The method according to claim 17, further comprising forming the front portion into two half portions separated by a relief cut and formed at an acute angle relative to one another.

19. The method according to claim 18, further comprising securing the two half portions of the front portion to the vertical flange on the mower deck of the riding mower such that the top portion covers at least a center section of the drive belt and pulley compartment.

20. A debris deflector for preventing debris from entering a drive belt and pulley compartment disposed on a mower deck of a riding mower, the deflector comprising:
a deflector made of a lightweight, formable material, the deflector comprising:
a generally planar top portion;
a front portion that depends downwardly from the top portion; and
an opposite rear portion that extends upwardly from the top portion;
wherein the front portion comprises two half portions that are separated by a relief cut and formed at an acute angle relative to one another, the geometry of the two half portions of the front portion corresponding to the angled geometry of a vertical flange that extends upwardly from the mower deck of the riding mower adjacent at least a center section of the drive belt and pulley compartment, the front portion having a plurality of through holes configured to receive a corresponding plurality of fasteners to secure the front portion to the vertical flange such that the top portion prevents debris from entering at least the center section of the drive belt and pulley compartment.
